(19) United States
(12) Patent Application Publication
(10) Pub. No.: US 2026/0303407 A1
(43) Pub. Date: Oct. 1, 2026

(54) Multi-Homing Device Handling of Host Changes During Control Plane Downtime

(71) Applicant: Arista Networks, Inc., Santa Clara, CA (US)

(72) Inventors: Anand Narayanan, Austin, TX (US); Mason Alexander Flowers, Austin, TX (US); Pavan Narasimhaprasad, Cedar Park, TX (US); Akhil Shashidhar, Cedar Park, TX (US)

(21) Appl. No.: 19/096,370

(22) Filed: Mar. 31, 2025

(51) Int. Cl. H04L 12/46; H04L 43/0805; H04L 45/16; H04L 65/70; H04L 69/22

(52) U.S. Cl. CPC H04L 12/4633; H04L 43/0805; H04L 45/16; H04L 65/70; H04L 69/22; H04L 2212/00

(57) ABSTRACT

A multi-homing network device may undergo an operation during which its control plane is inactive while its data plane remains active. During this operation, host changes such as host additions may occur in the network. To facilitate proper traffic handling for traffic destined for a new host, the multi-homing network device may perform traffic processing collectively with a multi-homing peer network device.

### BACKGROUND

This relates to network devices, including network devices configured to operate in a multi-homing configuration.

For example, a set of network devices that multi-homes a host can operate as a singular virtual entity from the perspective of the host and can each handle traffic to and from the host. In some instances, a given multi-homing network device can undergo hitless restart during which the control plane of the given network device becomes inactive. Some host changes such as host additions while the given network device undergoes hitless restart can cause undesired traffic forwarding behavior.

### BRIEF DESCRIPTION OF THE DRAWINGS

FIG. 1 is a diagram of an illustrative network having network devices in a multi-homing configuration in accordance with some embodiments.

FIG. 2 is a diagram of an illustrative network device in accordance with some embodiments.

FIG. 3 is a diagram of an illustrative multi-homing network device that experiences control plane downtime while its data plane receives traffic destined for a new local destination in accordance with some embodiments.

FIG. 4 is a diagram of illustrative data plane memory circuitry configured to store Ethernet segment information for handling remote-side ingress unknown unicast traffic in accordance with some embodiments.

FIG. 5 is a diagram of an illustrative encapsulated remote-side ingress unknown unicast packet tunneled to a peer multi-homing network device in accordance with some embodiments.

FIG. 6 is a diagram of an illustrative multi-homing network device that experiences control plane downtime while its data plane receives traffic destined for a new remote destination in accordance with some embodiments.

FIG. 7 is a diagram of illustrative data plane memory circuitry configured to store Ethernet segment information for handling local-side ingress unknown unicast traffic in accordance with some embodiments.

FIGS. 8A and 8B are diagrams of illustrative encapsulated local-side ingress unknown unicast packets tunneled to and from a peer multi-homing network device in accordance with some embodiments.

FIG. 9 is a diagram of an illustrative network device having control circuitry configured to store corresponding information for use by data plane processing circuitry when the control circuitry is inactive in accordance with some embodiments.

FIG. 10 is a diagram of an illustrative network device having control circuitry configured to store corresponding information for use by data plane processing circuitry when peer control circuitry is inactive in accordance with some embodiments.

FIG. 11 is a diagram of an illustrative network device configured to perform route advertisement for a new host that is multi-homed with a peer network device having an inactive control plane in accordance with some embodiments.

FIG. 12 is a flowchart of illustrative operations for operating a network device that experiences control plane downtime while its data plane remains active in accordance with some embodiments.

FIG. 13 is a flowchart of illustrative operations for operating a network device in connection with a peer network device that experiences control plane downtime in accordance with some embodiments.

### DETAILED DESCRIPTION

A network can convey network traffic (e.g., in the form of frames, packets, and/or other formats) between hosts. To properly forward the network traffic, the network can include a number of network devices. In an illustrative configuration, a set of network devices may be configured to multi-home a host or another network device, or generally a network portion. In this multi-homing configuration, the multi-homing network devices can serve as a single virtual entity from the perspective of the multi-homed device. Accordingly, when the multi-homed device communicates with the single virtual entity, any of the multi-homing network devices may receive traffic from the multi-homed device and/or any of the multi-homing network devices may transmit traffic to the multi-homed device.

In some scenarios, a given one of the multi-homing network devices can experience control plane downtime (e.g., as part of a planned control plane restart or update, as part of an unplanned event, etc.) during which its data plane is still functional. Because the control plane of the given network device is inactive, the control plane of the given network device may be unable to react and adapt device (data plane) operations in response to certain changes in the network. These changes can include host changes in the network such as host additions to the network. Without consideration of these issues, the given network device may undesirably process traffic without accounting for these network changes. This can cause issues such as substantial traffic flooding (e.g., caused by handling what would otherwise be known unicast traffic as unknown unicast traffic). In other instances, users (e.g., network administrators) may be undesirably restricted from making these host changes under these conditions (e.g., when the given network device has an inactive control plane).

To mitigate these issues and/or provide other advantages, a given network device may configure, prior to its control plane being inactive, its data plane to perform processing of traffic for a new host (e.g., unknown unicast traffic destined for the new host) in collaboration with a multi-homing peer network device. The traffic being processed can include remote-side ingress traffic when the new host is on a local network portion multi-homed by the multi-homing network devices. The traffic being process can include local-side ingress traffic when the new host is on a remote network portion with respect to the network portion multi-homed by the multi-homing network devices.

Accordingly, when the multi-homing network devices are appropriately configured (e.g., configured as described above and herein), limitations of certain host changes (e.g., certain host additions) can be removed during multi-homing network device control plane downtime, while still maintaining satisfactory traffic forwarding behavior. Illustrative details for the handling of traffic in connection with host changes by multi-homing network devices when the control plane of a multi-homing network device becomes inactive (while its data plane remains active) are further described herein.

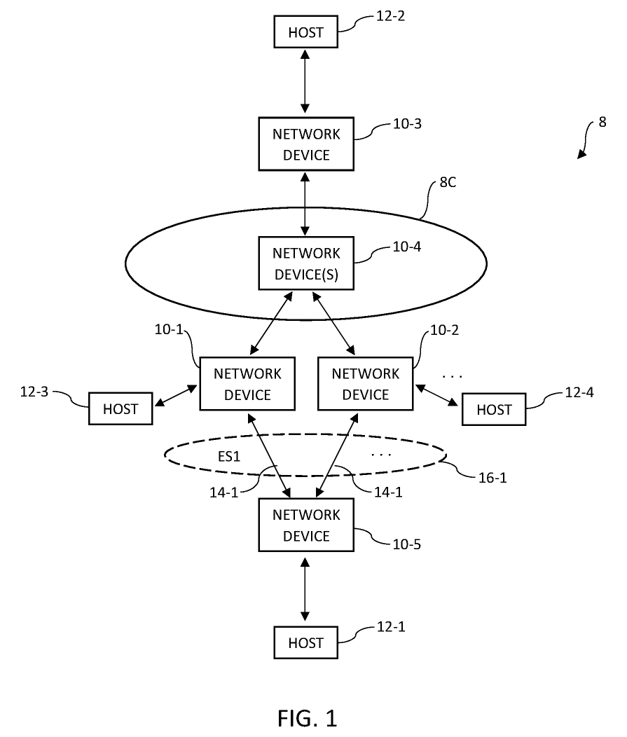

An illustrative network 8 that includes multi-homing network devices (e.g., configured to operate in the manner described above and generally herein) is shown in FIG. 1. In particular, network 8 may have any suitable scope. As examples, network 8 may include, be, and/or form part of one or more local segments, one or more local subnets, one or more local area networks (LANs), one or more virtual local area networks (VLANs), one or more campus area networks, one or more metropolitan area networks, one or more wide area networks, one or more datacenter networks, one or more cloud networks, etc. Network 8 may include any suitable number of different network devices that communicatively couple corresponding hosts of network 8 to one another.

Network 8 may include one or more wired portions with network devices interconnected based on wired technologies or standards such as Ethernet (e.g., using copper cables and/or fiber optic cables) and, if desired, one or more wireless portions implemented by wireless access point(s) (e.g., to form wireless local area network(s)). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

In the illustrative example of FIG. 1, network 8 may include a core network or core network portion 8C interconnecting different edge networks or edge network portions (e.g., different sites and/or different domains). As one illustrative example, core network portion 8C may include or form a backbone network such as one or more service provider networks (e.g., the Internet or other Internet Protocol (IP) service provider networks, MPLS networks, cloud provider networks, interconnect networks, etc.). The network devices in core network 8C may provide and implement underlying infrastructure over which overlay virtual extensible local area network (VXLAN)-based and/or MPLS-based network(s) are implemented. Core network portion 8C may connect different edge network portions belonging to entities (e.g., customers) different from (or the same as) those that provide core network portion 8C.

Core network portion 8C may include core network device(s) 10-4 (e.g., provider core network devices). These core network devices may be communicatively coupled to network devices 10-1, 10-2, and 10-3 (e.g., serving as provider edge network devices). Core devices 10-4 may be interconnected with each other within core network portion 8C. Network paths may communicatively couple one or more core devices 10-4 to edge devices 10-1, 10-2, and 10-3 that serve as interfacing network devices between core network portion 8C and devices in the edge network portions. These edge network portions (e.g., each representing different site(s), domain(s), etc.) may each include its own set of hosts and its own set of network devices between its hosts and corresponding edge devices (e.g., devices 10-1, 10-2, 10-3, etc.).

Hosts (e.g., hosts 12 such as host 12-1, host 12-2, host 12-3, host 12-4, etc.) of network 8 may be implemented on host equipment. Some hosts may be implemented on shared host equipment, while other hosts may each be implemented on a separate piece of host equipment. Host equipment (e.g., implementing hosts serving as end hosts of network 8 in an edge network portion or a site) may include computers, servers or server equipment, portable electronic devices such as cellular telephones, laptops, etc., network traffic storage devices, networking service devices, network management equipment that manages and controls the operation of one or more of hosts and/or network devices, and/or any other suitable types of specialized or general-purpose host computing equipment, e.g., running one or more client-side and/or server-side applications.

As shown in FIG. 1, network devices 10-1 and 10-2 may communicatively couple core network 8C to other network device(s) and/or host equipment (e.g., network device 10-5, host 12-1, host 12-3, host 12-4, etc.) of an edge network portion of network 8. In general, host(s) of the edge network portion may be communicatively coupled to a provider edge device (e.g., network device 10-1, network device 10-2, etc.) indirectly via one or more intervening network devices or directly attached (e.g., via cable(s), without an intervening network device) to the provider edge device.

In the example of FIG. 1 and in illustrative configurations sometimes described herein as an example, a host 12-1 may be communicatively coupled to each of network devices 10-1 and 10-2 via an intervening network device 10-5. In other illustrative configurations, host 12-1 may be communicatively coupled to network devices 10-1 and 10-2 without an intervening network device (e.g., without device 10-5) or with multiple intervening network devices. Similarly, host 12-3 may be communicatively coupled to network device 10-1 with or without intervening network device(s). Host 12-4 may be communicatively coupled to network device 10-2 with or without intervening network device(s).

As shown in FIG. 1, network device 10-3 may communicatively couple core network 8C to other network device(s) and/or host equipment (e.g., host 12-2) of another edge network portion (e.g., another customer network portion) of network 8. Host 12-2 may be communicatively coupled to network device 10-3 with or without intervening network device(s) in this edge network portion.

Network devices in network 8, such as network devices 10-4 in core network 8C, (provider) edge network devices 10-1, 10-2, and 10-3, and (customer or site) network devices in the edge network portions, may each include or be a switch (e.g., a single-layer (e.g., Layer 2) switch or a multi-layer (e.g., Layer 2 and Layer 3) switch), a bridge, a router, a gateway, a hub, a repeater, a firewall, a wireless access point, a network device serving other networking functions, a network device that includes the functionality of two or more of these devices, a management device that controls the operation of one or more of these network devices, and/or other types of network devices. Configurations in which network devices 10-1, 10-2, and 10-3 are (multi-layer) switches, routers, gateways, or network devices that generally include routing functionalities (e.g., implements routing protocols) are described herein as an illustrative example.

In some configurations described herein as an example, edge network devices 10-1, 10-2, and 10-3 may implement one or more Ethernet virtual private network (EVPN) instances over core network 8C, and accordingly, may be referred to as EVPN devices. In these illustrative configurations, the EVPN devices may exchange EVPN route information (e.g., Ethernet segment reachability information, hardware address reachability information, etc.) with one another over core network 8C. The EVPN route information may be exchanged based on any suitable underlying (transport layer and internet layer) protocol(s) that facilitate communication across core network 8C.

While network reachability information (e.g., Ethernet segment reachability information, hardware address reachability information, etc.) may be exchanged based on any suitable routing protocol, arrangements in which EVPN devices such as devices 10-1, 10-2, and 10-3 exchange network reachability information with one another using border gateway protocol (BGP), or more specifically multi-protocol BGP (MP-BGP), are described herein as an illustrative example. In these arrangements, devices 10-1, 10-2, and 10-3 may sometimes be referred to as BGP and/or EVPN speakers (e.g., configured to advertise and process corresponding advertised BGP messages containing EVPN route information). The use of BGP (e.g., MP-BGP) to implement the exchange of EVPN route information is merely illustrative. If desired, other routing protocols (or generally other control plane protocols) may be used to facilitate the exchange of EVPN route information between EVPN devices.

Still referring to FIG. 1, a set of edge network devices, such as network devices 10-1 and 10-2, may be configured in a network configuration that provides multi-homing for one or more devices (e.g., hosts, intervening network devices between the set of edge network devices and hosts, etc.) in an edge network portion. For example, a multi-homed network device 10-5 may have an interface (e.g., a port channel interface) coupled to a corresponding interface at network device 10-1 and coupled to a corresponding interface at network device 10-2. These interfaces of the three network devices may be coupled via corresponding links (e.g., Ethernet link 14-1 between the Ethernet interfaces of devices 10-1 and 10-5, Ethernet link 14-2 between Ethernet interfaces of devices 10-2 and 10-5). Network devices 10-1 and 10-2 may configure links 14-1 and 14-2 to collectively form an Ethernet segment 16-1 identified using the corresponding Ethernet segment identifier (ESID) ES1. Through links 14-1 and 14-2, network traffic can be conveyed to and from the multihomed device 10-5 and any other network devices and/or hosts (e.g., host 12-1) in the edge network portion behind device 10-5.

While two network devices 10-1 and 10-2 are shown to multi-home host 12-1 (through device 10-5) and two links 14-1 and 14-2 are shown to form Ethernet segment 16-1 in the example of FIG. 1, this is merely illustrative. If desired, any other suitable number of network devices (e.g., three network devices, more than three network devices, etc.) may multi-home host 12-1 and Ethernet segment 16-1 may include a corresponding Ethernet link for each of the network devices multi-homing host 12-1.

In some instances, some local hosts (e.g., in the same edge network portion as host 12-1 and device 10-5) may not be multi-homed by multiple edge network devices. As shown in the example of FIG. 1, host 12-3 may be communicatively coupled to network device 10-1 and may not be multi-homed behind an Ethernet segment. Similarly, host 12-4 may be communicatively coupled to network device 10-2 and may not be multi-homed behind an Ethernet segment.

While one illustrative Ethernet segment 16-1 is shown in the example of FIG. 1, this is merely illustrative. Multiple Ethernet segments may be provided for the edge network portion (to which hosts 12-1, 12-3, and 12-4 are local). In particular, if desired, network device 10-1 and other edge network device(s) (e.g., including or excluding network device 10-2, including network device 10-3, etc.) may form one or more other Ethernet segments for other hosts in the edge network portion. If desired, network device 10-2 and other edge network device(s) may form one or more other Ethernet segments for other hosts in the edge network portion.

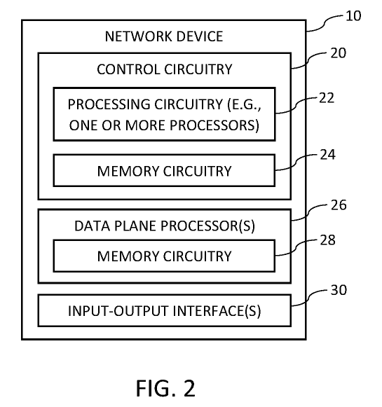

FIG. 2 is a diagram of an illustrative network device 10 (e.g., an illustrative multi-homing network device 10, different instances of which are usable to implement each of multi-homing network devices 10-1, 10-2, and 10-3 in FIG. 1). As shown in FIG. 2, network device 10 may include control circuitry 20 formed from processing circuitry 22 and memory circuitry 24, one or more data plane processors 26 (e.g., packet processors), and input-output interfaces 30 mounted on and/or within a housing of network device 10. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application-specific system processors (ASSPs), application-specific integrated circuit (ASIC) processors, and/or other types of processors.

Processing circuitry 22 may run (e.g., execute) a network device operating system and/or other software (including firmware) that is stored on memory circuitry 24 communicatively coupled to processing circuitry 22. Memory circuitry 24 may include one or more non-transitory (tangible) computer-readable storage media that store the operating system software and/or any other software code, sometimes referred to as program instructions, software, data, instructions, or code. As an example, the control plane operations performed by network device 10 described herein may be stored as (software) instructions on the one or more non-transitory computer-readable storage media (e.g., in portion(s) of memory circuitry 24). The corresponding processing circuitry (e.g., one or more processors of processing circuitry 22) may process or execute the respective instructions to perform the corresponding control plane operations.

Memory circuitry 24 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 10), and/or other types of memory circuitry. At least as described above, processing circuitry 22 and memory circuitry 24 (e.g., at least some portions of both) may sometimes be referred to collectively as control circuitry 20 (e.g., implementing or providing a control plane) of network device 10. Accordingly, processing circuitry 22 may sometimes be referred to as control plane processing circuitry 22 or control plane processor(s) 22.

As just a few examples, processing circuitry 22 may execute network device control plane software such as operating system software, routing policy management software, routing protocol or other protocol processes (e.g., a BGP process, an EVPN process, etc.), routing information base processes, and other control software, may be used to support the operation of protocol clients and/or servers (e.g., to form some or all of a communications protocol stack), may be used to support the operation of data plane processor(s) 26, may store packet forwarding information, may execute packet processing software, and/or may execute other software instructions that control the functions of network device 10 and the other components therein.

Data plane processor(s) 26 (e.g., packet processor(s)) may be used to implement a data plane or forwarding plane of network device 10. Accordingly, data plane processor(s) 26 may sometimes be referred to as data plane processing circuitry 26. Data plane processor(s) 26 may include one or more processors such as programmable logic devices (e.g., field programmable gate array (FPGA) devices), application-specific integrated circuit (ASIC) processors, application-specific system processors (ASSPs), central processing units (CPUs), graphics processing units (GPUs), microprocessors, general-purpose processors, host processors, microcontrollers, digital signal processors, and/or other types of processors.

Data plane processor 26 may receive incoming network traffic via input-output interfaces 30, parse and analyze the network traffic, process the network traffic based on packet forwarding decision data such as traffic processing rules (e.g., in a forwarding information base) and/or in accordance with network protocol(s) or other forwarding policy, and forward (or drop) the network traffic accordingly. The packet forwarding decision data may be stored on memory circuitry 28 (e.g., content-addressable memory such as ternary content-addressable memory) integrated as part of data plane processor 26 and/or, if desired, separate from data plane processor 26. Memory circuitry 28 (sometimes referred to as data plane memory circuitry 28) for data plane processor 26 may include volatile memory and/or non-volatile memory. The packet forwarding decision data may be stored in a portion of memory circuitry 24, if desired.

To interact with external devices, external systems, and/or users, network device 10 may include input-output interfaces 30 formed using corresponding input-output circuitry and/or interface circuitry. As an example, some input-output interfaces 30 (e.g., those for wired communication) may be implemented on physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment. As another example, some input-output interfaces 30 (e.g., those for wireless communication) may be implemented using wireless communications circuitry (e.g., antennas, transceivers, radios, etc.).

These examples of interfaces 30 are merely illustrative. If desired, interfaces 30 may include any suitable set of communication interfaces for connecting device 10 to the Internet, local area network(s), wide area network(s), WLAN network(s), generally network device(s) in these networks and in other networks, and/or other computing equipment (e.g., end hosts, server equipment, administrator devices, etc.). In some illustrative configuration described herein, interfaces 30 may include local-side interfaces 30 (e.g., local-network-facing interfaces such as front-panel interfaces) that communicatively couple device 10 to other devices in the edge network portions (e.g., multi-homed by device 10). Interfaces 30 may also include remote-side interfaces 30 (e.g., remote-network facing interfaces such as core network fabric interfaces) that communicatively couple device 10 to other devices in other edge network portions remote from the local edge network portions and/or that communicatively couple device 10 to network devices of an intervening network (e.g., devices 10-4 in network portion 8C) through which the remote network portions are reachable.

In illustrative configurations described herein as an example, input-output interfaces 30 may include Ethernet interfaces implemented using and therefore including (Ethernet) ports. In particular, data link layer interface circuitry may be coupled to the ports to form Ethernet interfaces with the desired interface configurations. Processing circuitry 22 may further form (e.g., configure) network layer interfaces (e.g., implemented over the Ethernet interfaces).

The components of network device 10 described in connection with FIG. 2 are merely illustrative. If desired, network device 10 may include any other suitable components. As examples, device 10 may include power management and/or supply circuitry and may include a system bus and/or other signal paths that communicatively couple the components of network device 10 to one another, that provide the components of network device 10 with power from the power management and/or supply circuitry, etc. In general, each component of network device 10 may be communicatively coupled to control circuitry 20 (e.g., processing circuitry 22 and/or memory circuitry 24) via one or more signal paths that enable the reception and transmission of control signals, data, and/or other information therebetween.

In configurations in which network device 10 implements an EVPN with EVPN peer device(s), processing circuitry 22 on network device 10 may execute an EVPN process. The EVPN process may manage and facilitate operations for implementing an EVPN such as the exchange of EVPN routes with other EVPN peer devices and the handling and processing of the exchanged information. If desired, the EVPN process may be implemented as part of a BGP process (e.g., performing operations in accordance with the border gateway protocol such as conveying EVPN route information in advertised BGP messages) executing on processing circuitry 22, or may be implemented separately from a BGP process that communicates with the EVPN process (e.g., both executing on processing circuitry 22).

A multi-homing network device 10 (e.g., one of device 10-1 or device 10-2 in FIG. 1) may sometimes perform a hitless restart operation or another operation during which the control plane of device 10 (e.g., control circuitry 20, and more specifically, control plane processing circuitry 22 of device 10) becomes inactive, while the data plane of the multi-homing network device 10 (e.g., data plane processor(s) 26, interface(s) 30, etc.) remains active. The hitless restart operation is intended to improve network operations by preserving data plane functionality while the control plane is inactive (e.g., being restarted as part of an update, as part of an operation to address a fault, etc.). However, undergoing this type of operation (e.g., with inactive control plane) can cause traffic forwarding issues (e.g., excessive traffic flooding) when there are host change(s) such as host additions to the network, because the control plane cannot react to these changes in the network and appropriately update device traffic forwarding behavior. This can often lead to restrictions being placed on certain network changes when a network device undergoes this type of operation, which is also undesirable because network administrator must delay these network changes to guaranteed desired forwarding behavior.

To mitigate these issues and/or impart other advantages, a multi-homing network device may be configured to appropriately handle, during its control plane downtime, traffic based on these types of host changes (e.g., host additions) with the help of multi-homing peer network device(s). Doing so can remove at least network administrator limitations on certain network changes being made during control plane downtime.

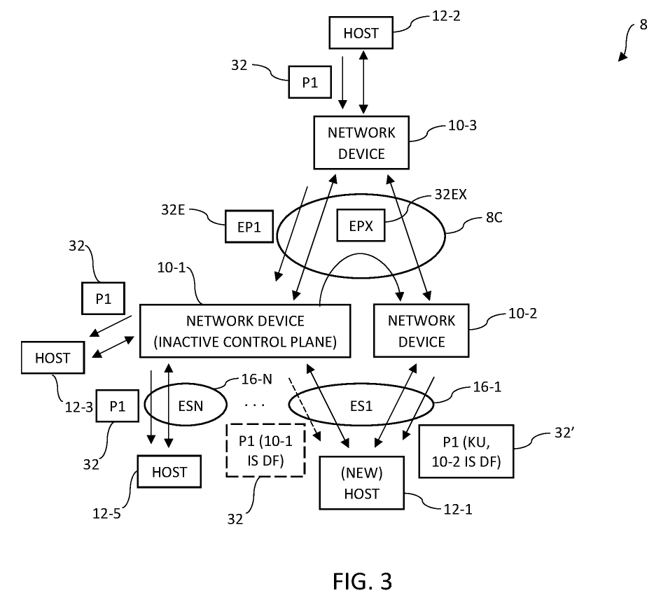

As one illustrative example, FIG. 3 shows a scenario in which network device 10-1 (FIG. 1) undergoes an operation during which control plane processing circuitry 22 of device 10-1 is inactive while data plane processor(s) 26 remain active, to receive, process, and/or transmit network traffic via interfaces 30. While the control plane of device 10-1 is inactive (or just before the control plane of device 10-1 became inactive), host 12-1 may be introduced as a new host local to the edge network portion multi-homed by device 10-1. In particular, host 12-1 may be multi-homed by devices 10-1 and 10-2 via Ethernet segment 16-1 (e.g., formed from links 14-1 and 14-2 to intervening device 10-5 in one illustrative configuration shown in FIG. 1). Due to the timing of the addition of host 12-1, control plane processing circuitry 22 of device 10-1 may not have learned of host 12-1 (e.g., may not have processed reachability information for host 12-1) before becoming inactive. Without doing more, device 10-1 would process remote-sourced traffic destined for (e.g., unicast to) host 12-1 as unknown unicast traffic and flood the received traffic. This can cause excessive traffic flooding, including traffic flooding to other remote edge network portions, which can lead to network congestion.

Accordingly, in illustrative configurations sometimes described herein as examples, device 10-1 may be configured to operate collectively with a multi-homing peer network device (e.g., device 10-2) to facilitate processing of remote-sourced traffic destined for host 12-1 while reducing at least some traffic flooding (e.g., remote flooding). In particular, in the example of FIG. 3, a host 12-2 on a remote edge network portion (e.g., remote relative to the local edge network portion containing host 12-1) may transmit a packet 32 (sometimes referred to as packet P1) destined for (e.g., unicast to) host 12-1. Packet 32 may be received by an edge network device 10-3 before being conveyed across network portion 8C. Device 10-3 may encapsulate packet 32 with a transport header (e.g., a tunneling header) for transport across network 8C to device 10-1 and transmit (e.g., tunnel) encapsulated packet 32E (sometimes referred to as packet EP1) to device 10-1 across network portion 8C (e.g., via network device(s) 10-4 in FIG. 1). For example, the transport header (e.g., tunneling header) of encapsulation packet 32E may identify device 10-1 as the destination (e.g., destination virtual tunnel end point) and may identify device 10-3 as the source (e.g., source virtual tunnel end point).

Data plane processor 26 (FIG. 2) of network device 10-1 may receive, at a remote-side interface 30 of device 10-1, encapsulated packet 32E. Upon receiving encapsulated packet 32E, data plane processor 26 of device 10-1 may decapsulate the transport header of encapsulated packet 32E to obtain the original packet 32, which is destined for host 12-1. However, because host 12-1 was introduced to network 8 before the control plane of device 10-1 has had a chance to learn of host 12-1 and appropriately program data plane processor 26 of device 10-1, data plane processor 26 of device 10-1 may not know how to forward packet 32 to reach host 12-1 (e.g., may not be programmed to perform unicast forwarding to host 12-1). According, based on the lack of the specific programming needed to unicast packet 32 to the specified packet destination thereon, data plane processor 26 of device 10-1 may be configured to process packet 32 as an unknown unicast packet, but do so in a modified manner to reduce excessive traffic flooding in network 8 (e.g., reduce remote flooding).

In particular, data plane processor 26 of device 10-1 may transmit (e.g., locally flood) packet 32 to local non-multi-homed hosts via corresponding local-side interfaces 30 (FIG. 2) of device 10-1. In the example shown in FIG. 3, data plane processor 26 of device 10-1 may transmit (e.g., flood) packet 32, via a local-side interface 30, to host 12-3 locally attached to device 10-1 but not multi-homed. A non-multi-homed host may sometimes be referred to as an orphan host for which a network device (e.g., device 10-1) serves as the exclusive edge network device through which the orphan host is communicatively coupled to network portion 8C.

Data plane processor 26 of device 10-1 may also transmit (e.g., locally flood) packet 32 to all Ethernet segment(s) that are not shared with remote network device 10-3 and of which device 10-1 is the designated forwarder. In the example shown in FIG. 3, data plane processor 26 of device 10-1 may transmit (e.g., flood) packet 32, via a local-side interface 30 and a corresponding link configured to form Ethernet segment 16-N (identified using Ethernet segment identifier ESN), to host 12-5 locally attached to device 10-1. In this example, device 10-1 may multi-home host 12-5 via Ethernet segment 16-N (shared) with one or more other multi-homing peer network devices that do not include device 10-3 (e.g., device 10-2 and/or another multi-homing peer network device) and may be the designated forwarder of Ethernet segment 16-N.

In one illustrative scenario in which device 10-1 is the designated forwarder (DF) for Ethernet segment 16-1 (shared with multi-homing peer network device 10-2 but not device 10-3), data plane processor 26 of device 10 may transmit (e.g., locally flood) packet 32, via a local-side interface 30 (e.g., forming link 14-1 in FIG. 1), to host 12-1 locally attached to device 10-1 (with or without intervening device 10-5 in FIG. 1). In general, packet 32 may be flood on all local-side interfaces 30 forming links of Ethernet segments not shared with remote device 10-3 and of which device 10-1 is the designated forwarder.

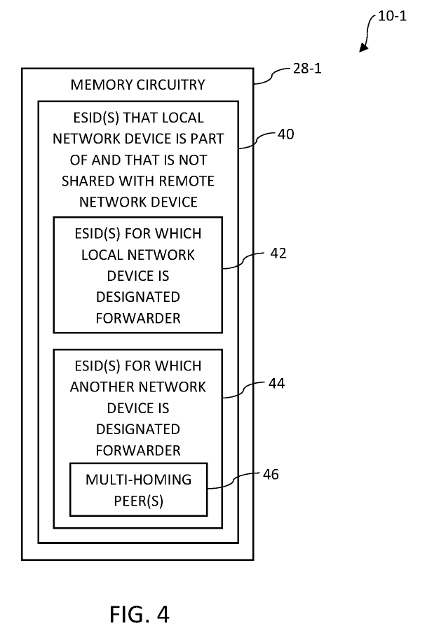

In order to determine which Ethernet segment(s) to flood packet 32, data plane processor(s) 26 of device 10-1 (e.g., data plane memory circuitry 28 of device 10-1) may be configured to maintain Ethernet segment information identifying the designated forwarder of each Ethernet segment that device 10-1 is part of. FIG. 4 is a diagram showing illustrative Ethernet segment information maintained (e.g., stored) on data plane memory circuitry 28 (FIG. 2) of device 10-1 (sometimes referred to as memory circuitry 28-1), or if desired, maintained on other memory circuitry accessible to data plane processor(s) 26 of device 10-1.

As shown in the example of FIG. 4, memory circuitry 28-1 may maintain (e.g., store) a list of Ethernet segment identifier(s), ESID(s), 40 identifying Ethernet segments that the local network device 10-1 is part of but the remote network device 10-3 is not part of (e.g., multi-homed by device 10-1 but not by device 10-3). Memory circuitry 28-1 may also identify (e.g., maintain an identifier of) the designated forwarder of each ESID 40. Of these ESID(s) 40, some ESID(s) 42 may identify device 10-1 as the designated forwarder, thereby identifying the corresponding Ethernet segments (and respective local-side interfaces 30 of device 10-1) through which packet 32 should be locally flooded as described above in connection with FIG. 3.

In addition to local flooding, via corresponding local-side interfaces 30, to Ethernet segments identified by ESID(s) 42 of which device 10-1 is the designated forwarder, data plane processor 26 of device 10-1 may also encapsulate packet 32 for transport to the other designated forwarder(s) of Ethernet segment(s) that device 10-1 is part of but not device 10-3 (e.g., not shared by device 10-3). In other words, of ESID(s) 40, some ESID(s) 44 (FIG. 4) may identify Ethernet segments of which other multi-homing peers 46 (e.g., peer network device 10-2 in FIG. 3 and other multi-homing peers) are the designated forwarders.

Referring back to the example of FIG. 3, in one illustrative scenario, multi-homing peer network device 10-2 may be the designated forwarder of Ethernet segment 16-1. In other words, ESID(s) 44 (FIG. 4) may include ESID ES1 which identifies device 10-2 as the designated forwarder of Ethernet segment 16-1 (instead of device 10-1 as described above in connection with another scenario). In this scenario, data plane processor 26 of device 10-1 may encapsulate packet 32 with a transport header (e.g., a tunneling header) to obtain encapsulated packet 32EX (sometimes referred to as encapsulated packet EPX). Data plane processor 26 of device 10-1 may transmit (e.g., tunnel), via a remote-side interface 30 of device 10-1, encapsulated packet 32EX to device 10-2 via network portion 8C. In addition to identifying the source of encapsulated packet 32EX (e.g., device 10-1 as the source virtual tunnel end point) and the destination of encapsulated packet 32EX (e.g., device 10-2 as the destination virtual tunnel end point), the transport header may also include an indication of how packet 32 encapsulated therein is to be processed by the receiving device 10-2.

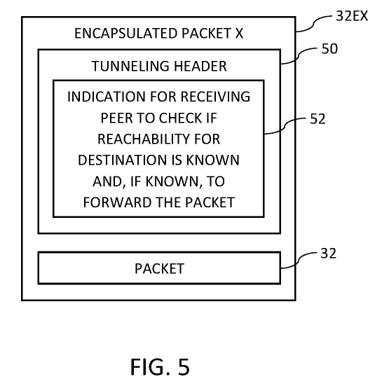

FIG. 5 is a diagram of an illustrative encapsulated packet 32EX (FIG. 3). In the example of FIG. 5, encapsulated packet 32EX may include the original packet 32 destined for host 12-1 encapsulated with tunneling header 50. Tunneling header 50 may be generated (e.g., populated) by data plane processor 26 of device 10-1 to include an indication 52 for the receiving multi-homing peer network device (e.g., device 10-2 in the example of FIG. 3) to check if reachability for the destination of packet 32 is known and, if known, to forward (e.g., unicast) packet 32.

Indication 52 may sometimes be referred to as an indication for remote-side ingress unknown unicast processing, as packet 32 is ingress traffic from a remote edge network portion and the unicast destination of packet 32 is not known to device 10-1 (e.g., because of the inactive control plane therein). In other words, indication 52 may serve as an indication for a multi-homing peer to assist in the processing of a possibly known unicast packet (e.g., having a destination unknown to device 10-1 but possibly known to the multi-homing peer).

Referring back to the example of FIG. 3, data plane processor 26 (FIG. 2) of device 10-2 may receive, at a remote-side interface 30 of device 10-2, encapsulated packet 32EX. Upon receiving encapsulated packet 32EX, data plane processor 26 of device 10-2 may identify indication 52 in the transport header (e.g., tunneling header 50 in FIG. 5) of encapsulated packet 32EX to determine the packet processing operation(s) for encapsulated packet 32EX. Based on indication 52 in encapsulated packet 32EX, data plane processor 26 of device 10-2 may determine whether packet 32 can be treated as a known unicast packet (e.g., whether the destination, host 12-1, of packet 32 and/or reachability of and forwarding interface for the destination are learned and known). Data plane processor 26 of device 10-2 may decapsulate the transport header of encapsulated packet 32EX to obtain packet 32. Based on determining that packet 32 can be treated as a known unicast (KU) packet, data plane processor 26 of device 10-2 may forward (e.g., unicast) packet 32 (e.g., as packet 32’ in FIG. 3) toward the intended destination, provided that the local-side interface 30 of device 10-2 through which forwarding of packet 32 would occur does not form an Ethernet segment of which device 10-1 is the designated forwarder.

Accordingly, if packet 32 is determined to be an actual unknown unicast packet (e.g., cannot be treated as a known unicast packet even by device 10-2 with the active control plane because reachability of the packet destination is unknown), data plane processor 26 of device 10-2 may drop packet 32 (e.g., without unicasting packet 32 toward its destination, without flooding packet 32 on interfaces 30 of device 10-2, etc.). Additionally, even if packet 32 can be treated as a known unicast packet, but the packet destination is behind an Ethernet segment shared with device 10-1 and having device 10-1 as the designated forwarder, data plane processor 26 of device 10-2 may still drop packet 32 (e.g., without unicasting packet 32 toward its destination, without flooding packet 32 on interfaces 30 of device 10-2, etc.).

While the example of FIG. 3 describes a single encapsulated packet 32EX being tunneled by device 10-1 to the designated forwarder of a single Ethernet segment, this is merely illustrative. In general, any number of encapsulated packets analogous to packet 32EX (e.g., containing the same packet 32, containing header 50 with the same indication 52, identifying device 10-1 as the source virtual tunnel end point, identifying the corresponding designated forwarder of the respective Ethernet segment shared with device 10-1 as the destination virtual tunnel end point, etc.) may be conveyed to the corresponding Ethernet segment designated forwarders identified as multi-homing peers 46 associated with ESIDs 44 in FIG. 4.

In illustrative configurations sometimes described herein as an example, transport over network portion 8C may be provided using a VXLAN overlay. Accordingly, the transport header of encapsulated packets 32E and 32EX may be VXLAN headers. In other words, in this example, tunneling header 50 of encapsulated packet 32EX in FIG. 5 may be a VXLAN header. In this example, indication 52 (FIG. 5) may be a first value provided using reserved (field) bits in the VXLAN header, or if desired, provided elsewhere in the VXLAN header. If desired, transport over network portion 8C may be provided using other techniques (e.g., using a MPLS overlay) and the corresponding transport header may be in accordance with these other techniques (e.g., a transport header containing MPLS labels, one or more of which may be used to provide a value serving as indication 52).

Configured in the manner described in connection with FIGS. 3-5, network device 10-1 may handle remote-ingress traffic (e.g., packet 32 from host 12-2) that is unknown unicast from the perspective of device 10-1 (but might be known unicast from the perspective of a multi-homing peer) with help from the multi-homing peer (e.g., device 10-2) while reducing some types of flooding and largely preserving appropriate forwarding behavior for actual unknown unicast traffic (e.g., unknown unicast traffic from the perspective of devices 10-1 and 10-2). For example, while device 10-1 locally floods packet 32 at certain interfaces associated with orphaned hosts and Ethernet segments of which device 10-1 is the designated forwarder, encapsulated packets with indication 52 provided to other designated forwarders of shared Ethernet segments will be dropped in the majority of cases (e.g., if packet 32 is determined to be an actual unknown unicast packet, if the packet destination is behind an Ethernet segment shared with device 10-1 and having device 10-1 as the designated forwarder, etc.).

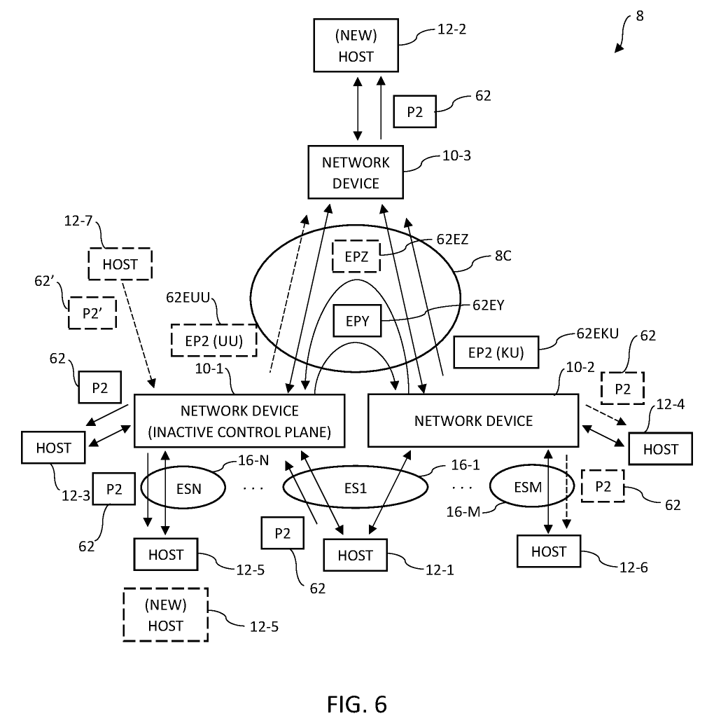

As another illustrative example, FIG. 6 shows a scenario in which network device 10-1 (FIG. 1) undergoes an operation during which control plane processing circuitry 22 of device 10-1 is inactive while data plane processor(s) 26 remain active, to receive, process, and/or transmit network traffic via interfaces 30. While the control plane of device 10-1 is inactive (or just before the control plane of device 10-1 became inactive), host 12-2 may be introduced as a new host remote to the edge network portion multi-homed by devices 10-1 and 10-2. In particular, host 12-2 may be local to the remote network portion for which device 10-3 serves as the edge device and may be communicatively coupled to multi-homing network devices 10-1 and 10-2 and host 12-1 through device 10-3 and intervening network portion 8C.

Due to the timing of the addition of host 12-2, control plane processing circuitry 22 of device 10-1 may not have learned of host 12-2 (e.g., may not have processed reachability information for host 12-2) before becoming inactive. Without doing more, device 10-1 would process local-sourced traffic destined for (e.g., unicast to) host 12-2 as unknown unicast traffic and flood the received traffic. This can cause excessive traffic flooding, including traffic flooding to other remote edge network portions, which can lead to network congestion.

Accordingly, in illustrative configurations sometimes described herein as examples, device 10-1 may be configured to operate collectively with a multi-homing peer network device (e.g., device 10-2) to facilitate processing of local-sourced traffic destined for host 12-2 while reducing at least some traffic flooding (e.g., remote flooding). In particular, in the example of FIG. 6, a host 12-1 on the local edge network portion (e.g., multi-homed by devices 10-1 and 10-2) may transmit a packet 62 (sometimes referred to as packet P2) destined for (e.g., unicast to) host 12-2. Packet 62 may be conveyed from host 12-1 to edge network device 10-1 over Ethernet segment 16-1 (e.g., with or without intervening device 10-5 in FIG. 1).

Data plane processor 26 (FIG. 2) of network device 10-1 may receive, at a local-side interface 30 of device 10-1, packet 62. However, because host 12-2 was introduced to network 8 before the control plane of device 10-1 has had a chance to learn of host 12-2 and appropriately program data plane processor 26 of device 10-1, data plane processor 26 of device 10-1 may not know how to forward (e.g., tunnel) packet 62 to reach host 12-2 (e.g., may not be programmed based on device 10-3 advertising reachability of host 12-2 to perform forwarding to host 12-2 via device 10-3). According, based on the lack of the specific programming needed to forward packet 62 to the specified packet destination thereon, data plane processor 26 of device 10-1 may be configured to process packet 62 as an unknown unicast packet, but do so in a modified manner to reduce excessive traffic flooding in network 8 (e.g., reduce remote flooding).

In particular, data plane processor 26 of device 10-1 may transmit (e.g., locally flood) packet 62 to local non-multi-homed hosts (sometimes referred to as orphan hosts of edge network device 10-1) via corresponding local-side interfaces 30 (FIG. 2) of device 10-1. In the example shown in FIG. 6, data plane processor 26 of device 10-1 may transmit (e.g., flood) packet 62, via a local-side interface 30, to orphan host 12-3 locally attached to device 10-1.

Data plane processor 26 of device 10-1 may also transmit (e.g., locally flood) packet 62 to all Ethernet segment(s) that device 10-1 is part of (excluding Ethernet segment 16-1 from which packet 62 is received), regardless of the designated forwarder(s) for the Ethernet segment(s). In the example shown in FIG. 3, data plane processor 26 of device 10-1 may transmit (e.g., flood) packet 62, via a local-side interface 30 and a corresponding link configured to form Ethernet segment 16-N (identified using ESID ESN), to host 12-5 locally attached to device 10-1. In this example, device 10-1 may multi-home host 12-5 via Ethernet segment 16-N (shared) with one or more other multi-homing peer network devices (e.g., device 10-2, device 10-3, and/or other multi-homing peer(s)).

In addition to local flooding, via corresponding local-side interfaces 30, to Ethernet segments (excluding Ethernet segment 16-1) that device 10-1 is part of, data plane processor 26 of device 10-1 may also encapsulate packet 62 for transport to a selected (e.g., arbitrarily pre-selected) multi-homing peer network device of the Ethernet segment on which packet 62 is received (e.g., device 10-2 or another multi-homing peer of device 10-1 on Ethernet segment 16-1).

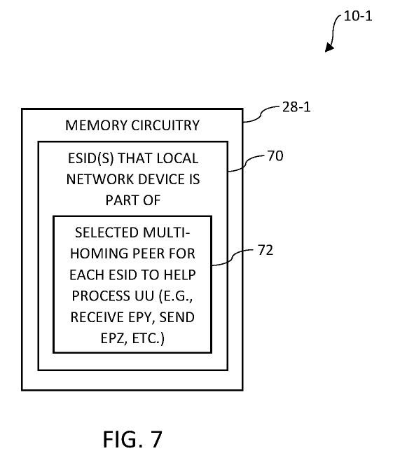

In order to identify the selected multi-homing peer to which an encapsulated version of packet 62 should be transported for each Ethernet segment device 10-1 is part of (e.g., such that local-sourced unknown unicast traffic from any of these Ethernet segments can be processed in the manner described above and generally herein), data plane processor(s) 26 of device 10-1 (e.g., data plane memory circuitry 28 thereof) may maintain Ethernet segment information identifying the pre-selected multi-homing peer of each Ethernet segment that device 10-1 is part of. FIG. 7 is a diagram showing illustrative Ethernet segment information maintained (e.g., stored) on data plane memory circuitry 28-1 of device 10-1, or if desired, maintained on other memory circuitry accessible to data plane processor(s) 26 of device 10-1.

As shown in the example of FIG. 7, memory circuitry 28-1 may maintain (e.g., store) a list of Ethernet segment identifier(s), ESID(s), 70 identifying Ethernet segments that the local network device 10-1 is part of (e.g., is multi-homed by). The list of ESIDs 70 may be or at least include the list of ESIDs 40 in FIG. 4. Memory circuitry 28-1 may also identify (e.g., maintain an identifier of) the selected multi-homing peer 72 for each ESID 70 to help process local-sourced unknown unicast traffic (e.g., packet 62). In the example of FIG. 6, multi-homing peer device 10-2 may be identified (e.g., by data plane processor 26 of device 10-1) as the selected multi-homing peer 72 for ESID ES1 (e.g., for Ethernet segment 16-1) to help process local-sourced unknown unicast traffic from host 12-1 on Ethernet segment 16-1. In a similar manner, data plane processor 26 of device 10-1 may identify, from Ethernet segment information maintained on memory circuitry 28-1, other selected multi-homing peer(s) 72 for other ESIDs (e.g., for other Ethernet segments) when processing corresponding local-sourced unknown unicast traffic from other hosts on these other Ethernet segments.

Referring back to FIG. 6, when data plane processor 26 of device 10-1 encapsulates packet 62 for transport to the selected multi-homing peer device 10-2 of Ethernet segment 16-1, data plane processor 26 of device 10-1 may more specifically encapsulate packet 62 with a transport header (e.g., a tunneling header) to obtain encapsulated packet 62EY (sometimes referred to as encapsulated packet EPY). Data plane processor 26 of device 10-1 may transmit (e.g., tunnel), via a remote-side interface 30 of device 10-1, encapsulated packet 62EY to device 10-2 via network portion 8C. In addition to identifying the source of encapsulated packet 62EY (e.g., device 10-1 as the source virtual tunnel end point) and the destination of encapsulated packet 62EY (e.g., device 10-2 as the destination virtual tunnel end point), the transport header may also include an indication of how packet 62 encapsulated therein is to be processed by the receiving device 10-2.

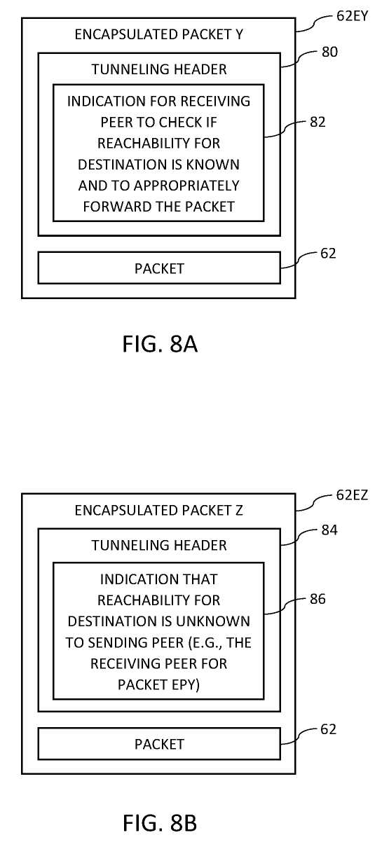

FIG. 8A is a diagram of an illustrative encapsulated packet 62EY (FIG. 6). In the example of FIG. 8A, encapsulated packet 62EY may include the original packet 62 destined for host 12-2 encapsulated with tunneling header 80. Tunneling header 80 may be generated (e.g., populated) by data plane processor 26 of device 10-1 to include an indication 82 for the receiving multi-homing peer network device (e.g., device 10-2 in the example of FIG. 6) to check if reachability for the destination of packet 62 is known and to appropriately forward (e.g., unicast or flood) packet 62 depending on whether the packet destination is known or unknown.

Indication 82 may sometimes be referred to as an indication for local-side ingress unknown unicast processing, as packet 62 is ingress traffic from a local edge network portion and the unicast destination of packet 62 is not known to device 10-1 (e.g., because of the inactive control plane therein). In other words, indication 82 may serve as an indication for a multi-homing peer to assist in the processing of a possibly known unicast packet (e.g., having a destination unknown to device 10-1 but possibly known to the multi-homing peer).

Referring back to the example of FIG. 6, data plane processor 26 (FIG. 2) of device 10-2 may receive, at a remote-side interface 30 of device 10-2, encapsulated packet 62EY. Upon receiving encapsulated packet 62EY, data plane processor 26 of device 10-2 may identify indication 82 in the transport header (e.g., tunneling header 80 in FIG. 8A) of encapsulated packet 62EY to determine the packet processing operation(s) for encapsulated packet 62EY. Data plane processor 26 of device 10-2 may decapsulate the transport header (e.g., tunneling header 80 in FIG. 8A) of encapsulated packet 62EY to obtain packet 62. Based on indication 82 in encapsulated packet 62EY, data plane processor 26 of device 10-2 may determine whether packet 62 can be treated as a known unicast packet (e.g., whether the destination, host 12-2, of packet 62 and/or reachability of and the forwarding interface of the destination are learned and known). Additionally, based on indication 82 in encapsulated packet 62EY, data plane processor 26 of device 10-2 may determine whether or not the destination of packet 62 is multi-homed behind one of the Ethernet segments multi-homed by device 10-1. Based on determining that packet 62 can be treated as a known unicast (KU) packet and that the destination of packet 62 is not behind an Ethernet segment multi-homed by device 10-1, data plane processor 26 of device 10-2 may forward (e.g., tunnel, unicast, etc.) packet 62 toward the intended destination.

In the example of FIG. 6, to forward packet 62 to destination host 12-2, data plane processor 26 of device 10-2 may convey packet 62 across network portion 8C to device 10-3. Accordingly, data plane processor 26 of device 10-2 may encapsulate packet 62 with a transport header (e.g., a tunneling header) to obtain encapsulated packet 62EKU. Data plane processor 26 of device 10-2 may transmit (e.g., tunnel), via a remote-side interface 30 of device 10-2, encapsulated packet 62EKU to device 10-3 via network portion 8C. The transport header may identify the source of encapsulated packet 62EKU (e.g., device 10-2 as the source virtual tunnel end point) and the destination of encapsulated packet 62EKU (e.g., device 10-3 as the destination virtual tunnel end point).

Alternatively, based on determining that packet 62 can be treated as a known unicast packet but that the destination of packet 62 is behind an Ethernet segment multi-homed by device 10-1, data plane processor 26 of device 10-2 may drop packet 62 (e.g., without forwarding packet 62 toward its destination, without flooding packet 62 on local interfaces 30 of device 10-2, without sending an additional encapsulated version of packet 62 back to device 10-1, etc.).

In a different scenario, data plane processor 26 of device 10-2 may determine that packet 62 is an actual unknown unicast packet (e.g., having a destination not only unknown to device 10-1, due to its control plane being inactive, but also unknown to device 10-2 with the active control plane), instead of a packet having a destination unknown to device 10-1 but known to device 10-2 (as described in the scenario above). Based on determining that packet 62 cannot be treated as a known unicast packet (e.g., is an actual unknown unicast packet because the reachability of the packet destination is unknown), data plane processor 26 of device 10-2 may transmit (e.g., locally flood) packet 62 to local non-multi-homed hosts (sometimes referred to as orphan hosts of edge network device 10-2) in the same broadcast domain as the packet source (e.g., host 12-1) via corresponding local-side interfaces 30 (FIG. 2) of device 10-2. In the example shown in FIG. 6, data plane processor 26 of device 10-2 may transmit (e.g., flood) packet 62, via a local-side interface 30, to orphan host 12-4 locally attached to device 10-2.

Based on determining that packet 62 cannot be treated as a known unicast packet, data plane processor 26 of device 10-2 may also transmit (e.g., locally flood) packet 62 to Ethernet segments that device 10-2 does not share with (e.g., does not multi-home hosts with) device 10-1 and of which device 10-2 is the designated forwarder. In the example shown in FIG. 6, data plane processor 26 of device 10-2 may transmit (e.g., flood) packet 62, via a local-side interface 30 and a corresponding link configured to form Ethernet segment 16-M (identified using ESID ESM), to host 12-6 locally attached to device 10-2. In this example, device 10-2 may multi-home host 12-6 via Ethernet segment 16-M (shared) with one or more other multi-homing peer network devices (e.g., device 10-3 and/or other multi-homing peer(s), not including device 10-1).

Based on determining that packet 62 cannot be treated as a known unicast packet, data plane processor 26 of device 10-2 may also encapsulate packet 62 for transport back to multi-homing peer device 10-1 of Ethernet segment 16-1 from which encapsulated packet 62EY was received. In particular, data plane processor 26 of device 10-2 may encapsulate packet 62 with a transport header (e.g., a tunneling header) to obtain encapsulated packet 62EZ (sometimes referred to as encapsulated packet EPZ). Data plane processor 26 of device 10-2 may transmit (e.g., tunnel), via a remote-side interface 30 of device 10-2, encapsulated packet 62EZ to device 10-1 via network portion 8C. In addition to identifying the source of encapsulated packet 62EZ (e.g., device 10-2 as the source virtual tunnel end point) and the destination of encapsulated packet 62EZ (e.g., device 10-2 as the destination virtual tunnel end point), the transport header may also include an indication of how packet 62 encapsulated therein is to be processed by the receiving device 10-1.

FIG. 8B is a diagram of an illustrative encapsulated packet 62EZ (FIG. 6). In the example of FIG. 8B, encapsulated packet 62EZ may include the original packet 62 destined for host 12-2 encapsulated with tunneling header 84. Tunneling header 84 may be generated (e.g., populated) by data plane processor 26 of device 10-2 to include an indication 86 for the receiving multi-homing peer network device (e.g., device 10-1 in the example of FIG. 6) that the reachability for the destination of packet 62 is unknown to the sending peer network device (e.g., device 10-2 in the example of FIG. 6, which is the receiving peer for encapsulated packet 62EY) and to forward (e.g., remotely flood) packet 62 based on unknown unicast traffic processing.

Indication 86 may sometimes be referred to as an indication of confirmation for actual (or genuine) local-side ingress unknown unicast processing of packet 62 originally received from the locally attached edge network portion (e.g., from host 12-1). In other words, responsive to indication 82 in encapsulated packet 62EY received by device 10-2, device 10-2 may provide indication 86 in the responding encapsulated packet 62EZ to confirm to device 10-1 that device 10-2 is unaware of reachability of the destination indicated in packet 62 (e.g., host 12-2) and that packet 62 is an actual unknown unicast packet and should be processed accordingly.

Referring back to the example of FIG. 6, data plane processor 26 (FIG. 2) of device 10-1 may receive, at a remote-side interface 30 of device 10-1, encapsulated packet 62EZ. Upon receiving encapsulated packet 62EZ, data plane processor 26 of device 10-1 may identify indication 86 in the transport header (e.g., tunneling header 84 in FIG. 8B) of encapsulated packet 62EZ to the appropriate packet processing operation(s) for encapsulated packet 62EZ. Data plane processor 26 of device 10-1 may decapsulate the transport header (e.g., tunneling header 84 in FIG. 8B) of encapsulated packet 62EZ to obtain packet 62. Based on indication 86 in encapsulated packet 62EZ, data plane processor 26 of device 10-1 may transmit (e.g., remotely flood), packet 62 (as an unknown unicast (UU) packet) to (remote) members of a floodlist for traffic sourced from Ethernet segment 16-1 (or more specifically a floodlist for traffic sourced from host 12-1). These members of the floodlist may include remote network devices (e.g., communicatively coupled to device 10-1 over network portion 8C) implementing the same Ethernet virtual private network instance as Ethernet segment 16-1 (e.g., intended to receive flooded traffic on Ethernet segment 16-1).

While the floodlist may include device 10-2 as a member, data plane processor 26 of device 10-1 may omit flooding of packet 62 to device 10-2, because packet 62 has already been conveyed and appropriately processed with the transmission and processing of encapsulated packet 62EY. In other words, based on indication 86 in encapsulated packet 62EZ, data plane processor 26 of device 10-1 may transmit (e.g., remotely flood), packet 62 (as an unknown unicast (UU) packet) to all members (except device 10-2) identified in the floodlist for traffic sourced from host 12-1. Flooding to these remote members over network portion 8C may include encapsulating packet 62 with corresponding transport header information (e.g., identifying these remote members as the destination virtual tunnel end points of the encapsulated packet) for transport over network portion 8C.

In the example of FIG. 6, one of the remote members of the floodlist may be device 10-3. To forward packet 62 to destination host 12-2, data plane processor 26 of device 10-1 may convey (e.g., flood) packet 62 (as an unknown unicast (UU) packet) across network portion 8C to device 10-3. Accordingly, data plane processor 26 of device 10-1 may encapsulate packet 62 with a transport header (e.g., a tunneling header) to obtain encapsulated packet 62EUU. Data plane processor 26 of device 10-1 may transmit (e.g., tunnel), via a remote-side interface 30 of device 10-1, encapsulated packet 62EUU to device 10-3 via network portion 8C. The transport header may identify the source of encapsulated packet 62EUU (e.g., device 10-1 as the source virtual tunnel end point) and the destination of encapsulated packet 62EUU (e.g., device 10-3 as the destination virtual tunnel end point).

Accordingly, device 10-3 may receive encapsulated packet 62EUU and decapsulate encapsulated packet 62UU and forward (e.g., flood) packet 62 to local hosts including the intended destination host 12-2 of packet 62.

In instances in which packet 62 is transported from device 10-2 to device 10-3 as encapsulated (known unicast) packet 62EKU, device 10-3 may receive encapsulated packet 62EKU and decapsulate encapsulated packet 62KU and forward (e.g., unicast) packet 62 to the intended destination host 12-2 of packet 62. In these instances, data plane processor 26 of device 10-2 may have determined that packet 62 is not an actual unknown unicast packet (e.g., is an unknown unicast packet only from the perspective of device 10-1 with the inactive control plane, but is a known unicast packet to device 10-2). Accordingly, in these instances, the transmission of encapsulated packet EPZ by device 10-2 to device 10-1, the (resulting) remote flooding of packet 62 to remote members of the floodlist by device 10-1 (e.g., transmission of encapsulated packet 62EUU), the flooding of packet 62 to orphan hosts of device 10-2 (e.g., to host 12-4), and the flooding of packet 62 to Ethernet segments not shared with device 10-1 and of which device 10-2 is the designated forwarder (e.g., to host 12-6) may be omitted.

While FIG. 6 as described above illustrates how traffic from host 12-1 is forwarded to new host 12-2, this is merely one illustrative example. Similar unknown unicast traffic processing (e.g., of possible known unicast traffic) may be performed for traffic to other types of destinations and/or from other types of sources.

As another example, instead of or in addition to multi-homed hosts (e.g., host 12-1) originating traffic (e.g., packet 62) destined for new remote host 12-2, orphan hosts (e.g., orphan host 12-7) may originate (e.g., transmit) traffic (e.g., packet 62’ shown in FIG. 6) destined for new remote host 12-2. In this example, upon receiving packet 62’, data plane processor 26 of device 10-1 may locally flood packet 62’ to other local non-multi-homed hosts via corresponding local-side interfaces 30 of device 10-1, may locally flood packet 62’ to all Ethernet segment(s) that device 10-1 is part of, and may encapsulate packet 62’ for transport across network portion 8C to a selected network device (e.g., device 10-2) with a corresponding indication 82 therein (as similarly described in connection with encapsulated packet 62EY). Upon receiving the encapsulated version of packet 62’ containing indication 82, data plane processor 26 of device 10-2 may forward (e.g., tunnel) packet 62’ to device 10-3 if reachability of the destination of packet 62’ is known (and the destination is not local to device 10-1). Alternatively, if the destination of packet 62’ (reachability thereof) is not known, data plane processor 26 of device 10-2 may locally flood packet 62’ to local non-multi-homed hosts of edge network device 10-2 in the same broadcast domain as the packet source (e.g., host 12-7) via corresponding local-side interfaces 30 of device 10-2, may locally flood packet 62’ to Ethernet segments that device 10-2 does not share with (e.g., does not multi-home hosts with) device 10-1 and of which device 10-2 is the designated forwarder, and may encapsulate packet 62’ for transport back to device 10-1 with a corresponding indication 86 therein (as similarly described in connection with packet 62EZ). Upon receiving the encapsulated version of packet 62’ containing indication 86, data plane processor 26 of device 10-1 may flood packet 62’ (as an unknown unicast (UU) packet) to all members (except device 10-2) identified in a floodlist for traffic sourced from host 12-7.

The illustrative processing described above in connection with packet 62’ from host 12-7 may similarly be used when the destination of packet 62’ is a new local host (locally attached to device 10-1) instead of a new remote host 12-2. As shown in the example of FIG. 6, packet 62’ may be destined for new host 12-5 (e.g., newly introduced while the control plane of device 10-1 is inactive) locally attached to device 10-1 (and multi-homed with device 10-2) over Ethernet segment 16-N. With the illustrative processing of packet 62’ described above, packet 62’ may still be locally flooded to new host 12-5 (when flooding packet 62’ to all Ethernet segment(s) that device 10-1 is part of). Data plane processor 26 of device 10-1 may still encapsulate packet 62’ for transport across network portion 8C to device 10-2 with a corresponding indication 82 therein. Upon receiving the encapsulated version of packet 62’ containing indication 82, data plane processor 26 of device 10-2 may determine that the reachability of the destination of packet 62’ is known but the destination is local to device 10-1. Based on this determination, data plane processor 26 of device 10-2 may drop packet 62’ to prevent duplicative delivery of packet 62’ to host 12-5 (which already received packet 62’ due to local flooding by device 10-1) and to prevent remote flooding by device 10-1 (e.g., by omitting the transmission of an encapsulated version of packet 62’ containing indication 86 back to device 10-1, which would cause the remote flooding).

In illustrative configurations sometimes described herein as an example, transport over network portion 8C may be provided using a VXLAN overlay. Accordingly, the transport header of encapsulated packets 62EY, 62EZ, 62EKU, and 62EUU may be VXLAN headers. In other words, in this example, tunneling header 80 of encapsulated packet 62EY in FIG. 8A and tunneling header 84 of encapsulated packet 62EZ in FIG. 8B may each be a VXLAN header. Accordingly, indication 82 (FIG. 8A) may be a second value (different from the first value for indication 52 in FIG. 5) provided using the reserved (field) bits in the VXLAN header, or if desired, provided elsewhere in the VXLAN header. Indication 86 (FIG. 8B) may be a third value (different from the first value for indication 52 and different from the second value for indication 82) provided using the reserved (field) bits in the VXLAN header, or if desired, provided elsewhere in the VXLAN header. If desired, transport over network portion 8C may be provided using other techniques (e.g., using a MPLS overlay) and the corresponding transport header may be in accordance with these other techniques (e.g., a transport header containing MPLS labels, one or more of which may be used to provide a value serving as indication 82 different from the value serving as indication 52 and one or more of which may be used to provide a value serving as indication 86 different from the values serving as indications 52 and 82).

Configured in the manner described in connection with FIGS. 6-8, network device 10-1 may handle local-ingress traffic (e.g., packet 62 from local host 12-1, packet 62’ from local host 12-7, etc.) that is unknown unicast from the perspective of device 10-1 (but might be known unicast from the perspective of a multi-homing peer) with help from the multi-homing peer (e.g., device 10-2), while reducing some types of flooding and largely preserving appropriate forwarding behavior for actual unknown unicast traffic (e.g., unknown unicast from the perspective of devices 10-1 and 10-2).

In preparation for the control plane downtime of device 10-1, data plane components (e.g., respective data plane processing circuitry 26) of network devices 10-1 and 10-2 may be configured (e.g., programmed) by the control plane components (e.g., respective control plane processing circuitry 22) of network devices 10-1 and 10-2 to perform the operations described in connection with FIGS. 3-8.

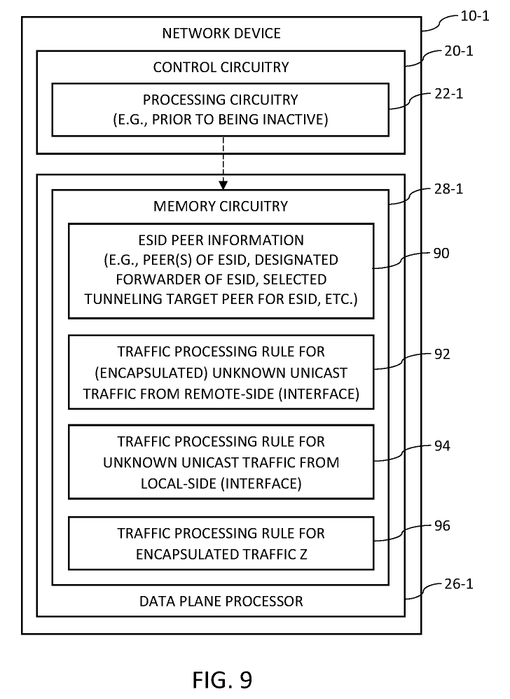

As shown in FIG. 9, network device 10-1 may include control circuitry 20-1 (e.g., an instance of control circuitry 20 in FIG. 2 for device 10-1) with corresponding processing circuitry 22-1 (e.g., an instance of processing circuitry 22 in FIG. 2 for device 10-1) and may include data plane processing circuitry such as a data plane processor 26-1 (e.g., an instance of data plane processor 26 in FIG. 2 for device 10-1) operating with data plane memory circuitry 28-1 (e.g., an instance of data plane memory circuitry 28 in FIG. 2 for device 10-1). Prior to control circuitry 20-1 (e.g., the control plane of device 10-1) being inactive (e.g., resulting from performing a hitless restart operation), control plane processing circuitry 22-1 may ensure that sufficient information has been programmed onto (e.g., stored on) data plane memory circuitry 28-1 to perform (by data plane processing circuitry of device 10-1) the operations described in connection with FIGS. 3-8, when control circuitry 20-1 is inactive. This information may be statically stored (e.g., pre-configured) on memory circuitry 28-1 (e.g., stored before, during, and after hitless restart, regardless of whether the control plane is active or inactive, etc.) and/or may be dynamically stored in response to initiation of hitless restart or generally based on determining that the local control plane of device 10-1 is going to be inactive. The dynamically stored information may be removed thereafter (e.g., after hitless restart completes, after the local control plane of device 10-1 becomes active again, etc.).

The information stored on memory circuitry 28-1, for use when control circuitry 20-1 is inactive, may include Ethernet segment identifier (ESID) (peer) information 90 such as peer network device(s) of device 10-1 for each Ethernet segment (or corresponding ESID) (e.g., information usable to identify ESIDs 40 in FIG. 4), the designated forwarder of each Ethernet segment (or corresponding ESID) (e.g., information usable to identify ESIDs 42 and 44 in FIG. 4), a selected tunneling target peer of each Ethernet segment (or corresponding ESID) (e.g., peers 72 in FIG. 7), and/or other types of Ethernet segment (identifier) information.

The information stored on memory circuitry 28-1, for use when control circuitry 20-1 is inactive, may include a set of traffic processing rules used by data plane processor 26-1 to make the determinations and perform the other corresponding operations described in connection with FIGS. 3-8. As shown in the example of FIG. 9, memory circuitry 28-1 may store a traffic processing rule 92 used by data plane processor 26-1 to match on and process encapsulated unknown unicast traffic received via remote-side interface(s) 30 of device 10-1 (e.g., to match on and process packet 32 in the manner described in connection with FIGS. 3-5). Memory circuitry 28-1 may store a traffic processing rule 94 used by data plane processor 26-1 to match on and process unknown unicast traffic received via local-side interface(s) 30 of device 10-1 (e.g., to match on and process packet 62 and packet 62’ in the manner described in connection with FIGS. 6-8). Memory circuitry 28-1 may store a traffic processing rule 96 used by data plane processor 26-1 to match on and process unknown unicast traffic encapsulated with indication 86 (FIG. 8B) and received via remote-side interface(s) 30 of device 10-1 from peer network device(s) such as device 10-2 (e.g., to match on and process packet 62EZ in the manner described in connection with FIGS. 6-8).

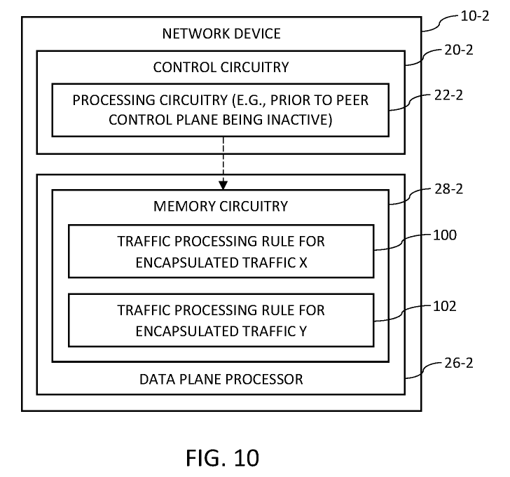

As shown in FIG. 10, network device 10-2 may include control circuitry 20-2 (e.g., an instance of control circuitry 20 in FIG. 2 for device 10-2) with corresponding processing circuitry 22-2 (e.g., an instance of processing circuitry 22 in FIG. 2 for device 10-2) and may include data plane processing circuitry such as a data plane processor 26-2 (e.g., an instance of data plane processor 26 in FIG. 2 for device 10-2) operating with data plane memory circuitry 28-2 (e.g., an instance of data plane memory circuitry 28 in FIG. 2 for device 10-2). Prior to control circuitry 20-1 (e.g., the control plane) of peer device 10-1 being inactive (e.g., resulting from performing a hitless restart operation), control plane processing circuitry 22-2 may ensure that sufficient information has been programmed onto (e.g., stored on) data plane memory circuitry 28-2 to perform (by data plane processing circuitry of device 10-2) the operations described in connection with FIGS. 3-8, when control circuitry 20-1 of peer device 10-1 is inactive. This information may be statically stored (e.g., pre-configured) on memory circuitry 28-2 (e.g., stored before, during, and after peer hitless restart, regardless of whether the peer control plane is active or inactive, etc.) and/or may be dynamically stored in response to initiation of hitless restart or generally based on determining that the control plane of peer device 10-1 is going to be inactive. The dynamically stored information may be removed thereafter (e.g., after peer hitless restart completes, after the peer control plane of device 10-1 becomes active again, etc.).

The information stored on memory circuitry 28-2, for use when peer control circuitry 20-1 is inactive, may include a set of traffic processing rules used by data plane processor 26-2 to make the determinations and perform the other corresponding operations described in connection with FIGS. 3-8. As shown in the example of FIG. 10, memory circuitry 28-2 may store a traffic processing rule 100 used by data plane processor 26-2 to match on and process unknown unicast traffic encapsulated with indication 52 (FIG. 5) and received via remote-side interface(s) 30 of device 10-2 from peer network device(s) such as device 10-1 (e.g., to match on and process packet 32EX in the manner described in connection with FIGS. 3-5). Memory circuitry 28-2 may store a traffic processing rule 102 used by data plane processor 26-2 to match on and process unknown unicast traffic encapsulated with indication 82 (FIG. 8A) and received via remote-side interface(s) 30 of device 10-2 from peer network device(s) such as device 10-1 (e.g., to match on and process packet 62EY as described in connection with FIGS. 6-8).

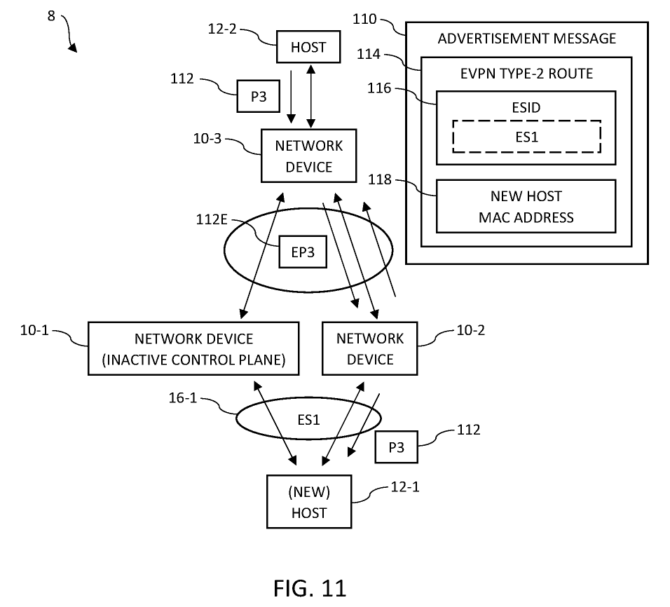

If desired, in addition to or instead of the operations described in connection with FIGS. 3-10, a multi-homing peer network device that operates with another network device having an inactive control plane may perform other operations to facilitate handling of host additions when the peer control plane is inactive. As shown in the example of FIG. 11 (e.g., as similarly described in connection with FIG. 3), devices 10-1 and 10-2 may multi-home a newly added host 12-1. Device 10-1 may operate with an inactive control plane when host 12-1 is introduced to network 8 (e.g., communicatively coupled to devices 10-1 and 10-2 through Ethernet segment 16-1). Accordingly, network traffic destined for host 10-2 if received by device 10-1, in some instances (e.g., when device 10-1 is not configured to perform the operations described in connection with FIGS. 3-6), may not be desirably processed (e.g., may lead to excessive traffic flooding).

To mitigate these issues and/or impart other advantages, control plane processing circuitry 22 (FIG. 2) of device 10-2 may alter the manner in which the reachability of host 12-1 is advertised based on the control plane of network device 10-1 being inactive or active. In particular, processing circuitry 22 of device 10-2 may determine that control plane processing circuitry 22 (FIG. 2) of network device 10-1 is inactive. As illustrative examples, processing circuitry 22 of device 10-2 may make this determination based on a communication connection (e.g., a transmission control protocol (TCP) connection) between devices 10-1 and 10-2 being terminated by device 10-1 and/or based on other criteria being met. Based on determining that the control plane of device 10-1 is inactive, processing circuitry 22 of device 10-2 may advertise reachability of any new host multi-homed with device 10-1 without identifying the corresponding Ethernet segment via which the new host is multi-homed.

In the example of FIG. 11, based on host 12-1 being added and based on determining that the control plane of peer device 10-1 is inactive, processing circuitry 22 of device 10-2 may transmit a route advertisement message 110 (e.g., a BGP message) containing an EVPN type-2 (MAC-IP) route 114 advertising the reachability of host 12-1 (e.g., the media access control (MAC) address of host 12-1). Route information for route 114 may include, among other information, an ESID 116 and MAC address 118 of new host 12-1. When the control plane of peer device 10-1 is inactive, processing circuitry 22 of device 10-2 may populate ESID 116 with a value of zero (e.g., omitting an indication of ESID ES1 therein), thereby indicating, to receiving network devices such as device 10-3, that no ESID or Ethernet segment is associated with host 12-1 and effectively indicating that host 12-1 is an orphan host of device 10-2. Accordingly, remote-side ingress traffic such as packet 112 from host 12-2 may be tunneled (e.g., as encapsulated packet 112E) by device 10-3 to device 10-2 because device 10-3 (based on processing route 114 in message 110) will (always) convey packet 112 to host 12-1 via device 10-2 (and not via device 10-1). Upon receiving encapsulated packet 112E, data plane processor 26 (FIG. 2) of device 10-2 may decapsulate packet 112E to obtain packet 112 and forward packet 112 to host 12-1. Upon the control plane of device 10-1 becoming active again, processing circuitry 22 of device 10-2 may advertise an updated version of EVPN type-2 route 114 with ESID 116 populated with the ES1 value, thereby associating reachability of host 12-1 with Ethernet segment 16-1.

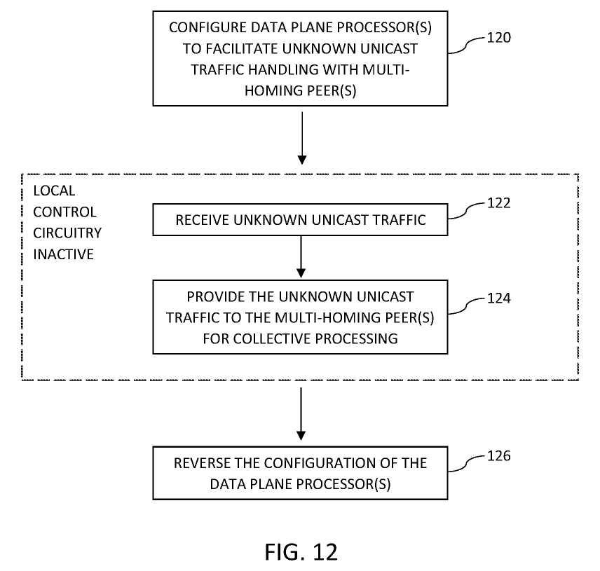

FIG. 12 is a flowchart of illustrative operations performed by a multi-homing network device configured to operate with an inactive local control plane while operating with an active data plane (e.g., configured to perform a hitless restart operation). Some illustrative operations described in connection with FIG. 12 may be performed by one or more processors of one of the multi-homing network devices described herein (e.g., processing circuitry 22 of FIG. 2 for device 10-1) by executing software instructions stored on corresponding memory circuitry in the multi-homing network device (e.g., memory circuitry 24 of FIG. 2 for device 10-1). Some illustrative operations described in connection with FIG. 12 may be performed by other dedicated hardware components in the multi-homing network device (e.g., data plane processor(s) 26 of FIG. 2 for device 10-1).

At block 120, control circuitry (e.g., one or more control plane processors) of a multi-homing network device may configure its data plane processing circuitry to facilitate unknown unicast traffic handling with multi-homing peer(s). This configuration can involve the generation and storage (e.g., the installation, programming, etc.) of traffic processing rules and other information (e.g., ESID information) on memory circuitry of the data plane processing circuitry. The operations at block 120 may be performed and completed prior to the control circuitry performing a hitless restart operation (e.g., as part of the shutdown procedure in preparation for hitless restart), or otherwise prior to the control circuitry becoming inactive while its data plane processing circuitry remains active and operational. As an example, the operations performed at block 120 may include one or more operations performed by device 10-1 as described in connection with FIG. 9 (e.g., storage of information 90 and processing rules 92, 94, and 96).

After the operations at block 120, the local control circuitry of the multi-homing network device may undergo hitless restart, during which the operations at blocks 122 and 124 may be performed. At block 122, the data plane processing circuitry of the multi-homing network device may receive unknown unicast traffic such as remote-side ingress unknown unicast traffic and local-side ingress unknown unicast traffic while the local control circuitry is inactive. At block 124, in addition to performing local data plane processing of the received unknown unicast traffic, the data plane processing circuitry of the multi-homing network device may provide, based on the configuration of the data plane processing circuitry by the local control circuitry (at block 120), the unknown unicast traffic to the multi-homing peer(s) for collective processing. In illustrative configurations described herein, the received unknown unicast traffic may be modified (e.g., encapsulated), based on the configuration of the data plane processor(s) by the local control circuitry (at block 120), to include additional indications for peer processing when forwarded to the multi-homing peer(s). As an example, the operations performed at blocks 122 and 124 may include one or more operations performed by device 10-1 as described in connection with FIGS. 3-8.

After the local control circuitry is active again, at block 126, the local control circuitry of the multi-homing network device may reverse the configuration of the data plane processing circuitry such that future (un)known unicast traffic based on host changes can be handled locally, instead of being forwarded toward the peer multi-homing network device. This reversing of the data plane processor configuration may include removing, deleting, or otherwise disabling the information and/or the traffic processing rules programmed at block 120. In some instances, at least some of the data plane processor configuration (e.g., information 90 and traffic processing rule 96 in FIG. 9) may be static (e.g., persistent) and not removed at block 126 because they do not affect local processing of future (un)known unicast traffic based on host changes.

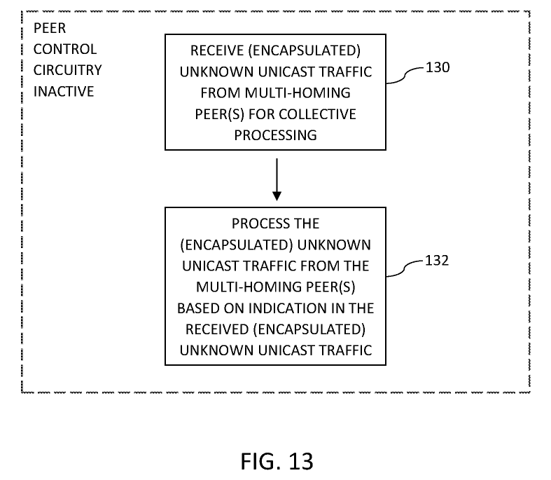

FIG. 13 is a flowchart of illustrative operations performed by a multi-homing network device whose peer multi-homing network device is operating with an inactive control plane (e.g., is performing a hitless restart operation). Some illustrative operations described in connection with FIG. 13 may be performed by one or more processors of one of the multi-homing network devices described herein (e.g., processing circuitry 22 of FIG. 2 for device 10-2) by executing software instructions stored on corresponding memory circuitry in the multi-homing network device (e.g., memory circuitry 24 of FIG. 2 for device 10-2). Some illustrative operations described in connection with FIG. 13 may be performed by other dedicated hardware components in the multi-homing network device (e.g., data plane processor(s) 26 of FIG. 2 for device 10-2).

In general, the operations described in connection with FIG. 13 may be performed while a first peer multi-homing network device, operating with the second multi-homing device performing these operations of FIG. 13, is operating with an inactive control plane (e.g., is performing a hitless restart operation). This first peer multi-homing network device may be same (peer) multi-homing network device performing the operations of blocks 122 and 124 in FIG. 12 while operating with the inactive control plane.

At block 130, the data plane processing circuitry of the multi-homing network device may receive (encapsulated) unknown unicast traffic from multi-homing peer(s) (with inactive control plane) for collective processing with the local multi-homing network device. At block 132, the data plane processing circuitry of the multi-homing network device may process the (encapsulated) unknown unicast traffic from the multi-homing peer(s) (with inactive control plane) based on the corresponding indication in (the encapsulation header of) the received (encapsulated) unknown unicast traffic. As an example, the operations performed at blocks 130 and 132 may include one or more operations performed by device 10-2 as described in connection with FIGS. 3-8.

The methods and operations described above in connection with FIGS. 1-13 may be performed by the components of one or more network devices and/or server or other host equipment using software (including firmware) and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server or other host equipment. The software code may sometimes be referred to as software, data, instructions, program instructions, or code. The one or more non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., by one or more processors of network devices 10-1 and 10-2 as described herein).

The foregoing is merely illustrative and various modifications can be made to the described embodiments. The foregoing embodiments may be implemented individually or in any combination.

What is claimed is:

1. A network device operable with a peer network device in a multi-homing configuration, the network device comprising:
memory circuitry;
control plane processing circuitry coupled to the memory circuitry; and
data plane processing circuitry coupled to the control plane processing circuitry and configured to:
obtain an unknown unicast packet while the control plane processing circuitry is inactive; and
forward an encapsulated version of the unknown unicast packet to the peer network device, the encapsulated version of the unknown unicast packet having a tunneling header that includes an indication of how the unknown unicast packet is to be processed by the peer network device.

2. The network device defined in claim 1, wherein the indication is comprises an indication for the peer network device to determine if reachability of a destination of the unknown unicast packet is known.

3. The network device defined in claim 2, wherein the unknown unicast packet is destined for a new local host multi-homed by the network device and the peer network device over an Ethernet segment.

4. The network device defined in claim 3, wherein the peer network device is a designated forwarder of the Ethernet segment.

5. The network device defined in claim 4, wherein the data plane processing circuitry is configured to transmit the unknown unicast packet to an orphan host of the network device.

6. The network device defined in claim 5, wherein the unknown unicast packet is obtained from an encapsulated packet from a remote network device, wherein the data plane processing circuitry is configured to transmit the unknown unicast packet to an additional Ethernet segment multi-homed by the network device but not by the remote network device, and wherein the network device is the designated forwarder of the additional Ethernet segment.

7. The network device defined in claim 2, wherein the unknown unicast packet is destined for a new remote host communicatively coupled to the network device and the peer network device over a core network portion.

8. The network device defined in claim 7, wherein the unknown unicast packet is sourced from a local host multi-homed by the network device and the peer network device over an Ethernet segment, wherein the data plane processing circuitry comprises data plane memory circuitry configured to identify the peer network device as a selected peer network device for the Ethernet segment, and wherein the encapsulated version of the unknown unicast packet is forwarded to the peer network device based on the peer network device being identified as the selected peer network device for the Ethernet segment.

9. The network device defined in claim 8, wherein the data plane processing circuitry is configured to transmit the unknown unicast packet to an orphan host of the network device.

10. The network device defined in claim 9, wherein the data plane processing circuitry is configured to transmit the unknown unicast packet to an additional Ethernet segment multi-homed by the network device.

11. The network device defined in claim 8, wherein the data plane processing circuitry is configured to receive an additional encapsulated version of the unknown unicast packet from the peer network device, the additional encapsulated version of the unknown unicast packet having a tunneling header that includes an indication of reachability of a destination of the unknown unicast packet being unknown.

12. The network device defined in claim 11, wherein the data plane processing circuitry is configured to flood the unknown unicast packet to members of a floodlist for traffic sourced from the local host based on the indication of reachability of the destination of the unknown unicast packet being unknown and wherein the members of the floodlist to which the unknown unicast packet is flooded excludes the peer network device.

13. The network device defined in claim 7, wherein the unknown unicast packet is sourced from an orphan host of the network device.

14. The network device defined in claim 2, wherein the unknown unicast packet is destined for a new local host multi-homed by the network device and the peer network device over an Ethernet segment and is sourced from an orphan host of the network device.

15. A network device operable with a peer network device in a multi-homing configuration, the network device comprising:
memory circuitry;
control plane processing circuitry coupled to the memory circuitry; and
data plane processing circuitry coupled to the control plane processing circuitry and configured to:
receive an encapsulated version of an unknown unicast packet from the peer network device when a control plane of the peer network device is inactive, the encapsulated version of the unknown unicast packet having a tunneling header that includes an indication of how the unknown unicast packet is to be processed; and
based on the indication, forward the unknown unicast packet as a known unicast packet to a destination of the unknown unicast packet based on reachability of the destination being known.

16. The network device defined in claim 15, wherein the unknown unicast packet is destined for a new local host multi-homed by the network device and the peer network device over an Ethernet segment and wherein the network device is a designated forwarder of the Ethernet segment.

17. The network device defined in claim 15, wherein the unknown unicast packet is destined for a new remote host communicatively coupled to the network device and the peer network device over a core network portion via a remote network device and wherein the known unicast packet is forwarded to the new remote host as the destination by tunneling the known unicast packet over the core network portion to the remote network device.

18. The network device defined in claim 15, wherein the data plane processing circuitry is configured to:
determine that the reachability of the destination is unknown; and
based on the reachability of the destination being unknown,
transmit the unknown unicast packet to an orphan host of the network device,
transmit the unknown unicast packet to an Ethernet segment multi-homed by the network device but not by the peer network device, the network device being the designated forwarder of the Ethernet segment, and
transmit an additional encapsulated version of the unknown unicast packet to the peer network device, the additional encapsulated version of the unknown unicast packet having a tunneling header that includes an indication of the reachability of the destination being unknown.

19. A network device comprising:
control circuitry configured to perform a hitless restart operation; and
a data plane processor coupled to the control circuitry and having data plane memory circuitry, wherein the data plane memory circuitry is configured to store:
for use during the hitless restart operation,
an Ethernet segment identifier,
a designated forwarder of the Ethernet segment,
a selected multi-homing peer of the Ethernet segment,
a first traffic processing rule for matching on and processing remote-side ingress unknown unicast traffic,
a second traffic processing rule for matching on and processing local-side ingress unknown unicast traffic, and
a third traffic processing rule for matching on and processing encapsulated unknown unicast traffic from the selected multi-homing peer.

20. The network device defined in claim 19, wherein the data plane processor is configured to process a first unknown unicast packet based on the first traffic processing rule at least in part by tunneling an encapsulated version of the first unknown unicast packet to the designated forwarder and wherein the data plane processor is configured to process a second unknown unicast packet based on the second traffic processing rule at least in part by tunneling an encapsulated version of the second unknown unicast packet to the selected multi-homing peer.
